(19) United States
(12) Patent Application Publication
(10) Pub. No.: US 2025/0241729 A1
(43) Pub. Date: Jul. 31, 2025

(54) Double Bladed Dental Elevator

(71) Applicant: David Fyffe, Dallas, TX (US)

(72) Inventor: David Fyffe, Dallas, TX (US)

(21) Appl. No.: 18/423,485

(22) Filed: Jan. 26, 2024

(51) Int. Cl. A61C 3/14

(52) U.S. Cl. CPC A61C 3/14

(57) ABSTRACT

The invention prescribes a dental tooth elevator for dental use, one embodiment of which exhibits a doubled bladed instrument formed by a U-shaped notch which resists bending for extracted teeth and gum line when embedded to expand and loosen teeth between tooth and bone both mesio-distal (backward) and bucco-lingual (side-to-side) as said elevator is twisted by operator increasing tooth movement while, unlike traditional straight elevators, the flat tipped doubled blades further resists slippage during tooth extraction.

### CROSS-REFERENCE TO RELATED APPLICATIONS

None

### TECHNICAL FIELD

The present invention relates to dental instruments, particularly devices that aid in tooth extraction.

RELEVANT PATENT PRIOR ART REFERENCES

| | | | |
|---|---|---|---|
| JP 2023-139779 A | Mar. 22, 2022 | Tooth Extraction | Iwaki |
| 2023.10.4 | | Instrument | |
| US 2010/0143866 | Dec. 24, 2009 | Periotome | Lasner |
| A1 | | | |
| WO 2012/022028 | Aug. 17, 2010 | Multi-Rooted Tooth | Li |
| A1 | | Extraction Device | |
| WO 2020/175713 | Feb. 25, 2020 | Tooth Extraction | Suzuki |
| A1 | | Tool | |
| EP 3 441 040 | Feb. 14, 2017 | Tooth Extraction | Nishio |
| A1 | | Instrument | |
| CN 110693614 | Oct. 9, 2019 | Minimally Invasive | Wenchao |
| A | | Tooth Extraction | |
| U.S. Pat. No. 8,435,035 | Nov. 16, 2011 | Dental Instrument | Fahad |
| B1 | | | |

### DESCRIPTION OF THE RELATED ART

The present invention relates to improvements in dental tools, specifically an enhanced version of a previously known instrument in the dental industry, referred to as the “Diamond-V”. The “Diamond-V” was notable for its V-shaped notch with very pointed tips. This product was available in the market from Sep. 12, 2012, to Feb. 9, 2023, and has since been superseded by the present invention. The present inventor created the “Diamond-V” and improved on it as further shown in this application.

The “Diamond-V” and similar instruments, including those described in the '779 Iwaki patent, were designed to penetrate deep into the bone or periodontal ligament space. However, these instruments, as depicted in FIGS. 1 through 4, had a critical drawback: their extremely thin, pointed tips were prone to bending and breaking under force (6). This was particularly evident when the instrument's handle was twisted during use, causing lateral force and resulting in the deformation or breakage of the tips, as shown in FIG. 2. '779 Iwaki patent appears to be a replication of what was on sale in the U.S. at least as early as Sep. 12, 2012. Diamond-V″ and the '779 Iwaki patent have two pointed thin tips at the top of the instrument, a critical flaw which is resolved in the present invention.

Further examples of the prior art which mirror the flaws of the Diamond-V″ and the '779 Iwaki patent can be found in veterinary extraction elevators from the following companies: OSUNG USA, V-Notch Periosteal Elevator, FIG. 10A; JorVet; Denta Elevator w/V Top, FIG. 10B; Peak Surgicals, Notched Elevator, FIG. 10C; and GerVetUsa, Notched Elevator, FIG. 10D. All have two pointed thin tips at the top of such instruments prone to breakage under ordinary use and operator pressure.

### SPECIFICATION

The present invention addresses these shortcomings of the prior-art by introducing a tool with squared-off flat blade tips at the top of the instrument, which are both durable and markedly resistant to bending and breaking. Unlike its predecessors, the present invention does not penetrate deeply into the periodontal ligament space. Instead, it engages shallowly, allowing the operator to maintain the position of the squared-off tip through a strong downward, apical force. This design facilitates repeated back-and-forth twisting combined with a downward pushing motion, effectively moving the tooth laterally away from the instrument without promoting tip breakage. A significant aspect of the present invention involves the unique design of the tool tips, characterized by a U-shaped end. This design notably enhances the strength of the tool and reduces the likelihood of damage during use. Moreover, a distinctive feature of this invention is observed during its application. As the tool is turned sideways, the blades of tips become oriented along their broader dimension, effectively widening the tool. This wider, sideways orientation of the blades of tips provides greater strength and resilience, a marked improvement over the thin, pointed tips of the “Diamond-V” and the '779 Iwaki patent. Illustrated in FIGS. 9A through 9C are various curvature variations of the present invention. These curvatures are specifically designed to conform to anatomical structures and facilitate entry angles for tooth extractions, thereby allowing for quicker and more effective procedures.

The present invention is conceptualized as a tooth extraction instrument, adept at handling tooth roots of diverse sizes and shapes. Its design and functionality significantly shorten the tooth extraction process, thereby reducing the patient's discomfort and procedural time. The instrument comprises several key components: Gripper (7): Facilitates a firm grip on the tooth; Thumb and Pointer Finger Support Notch (18): Provides ergonomic support for the user's fingers, enhancing control and precision; Shaft (9): The shaft may exhibit different curvatures, as exemplified in elements 15, 16, or 17, to accommodate various dental structures and extraction angles; and shaft reduction area (10): This area leads to the exposure of the wider U-shaped end of the tool blade tips (11), which is instrumental in the extraction process. The flat tool blade tips (11) engage the gum line and alveolar bone (14) against the tooth (12) as twisted by the operator both mesio-distal (backward) and bucco-lingual (side-to-side) to extract the tooth (12) along the shaft reduction area (10) which encourages the lifting of the tooth (12). Further, the shaft reduction area (10) is a corrugated (or rough area) which is capable of assisting and gripping the tooth (12) during extraction. Said shaft reduction area (10) is about 13 mm inclusive of the connected corrugated (or rough area) of the blade tips (11). The side of the shaft (9) opposite the shaft reduction area (10) is smooth to protect the gumline. In smaller mouths, such as in children, the shaft reduction area (10) area could be as small as 5 mm up to 13 mm.

The tool comprises two flat top blade tips (11) separated by a fixed distance. The separation between the tips is about 2 mm. Each blade tip has a diameter of about 1 mm. Alternative versions of the blade tip could range between from about 0.5 mm in diameter to about 1.5 mm in diameter. The cumulative distance spanning from the outer edge of the first blade tip to the outer edge of the second blade tip measures about 4 mm. The cumulative distance spanning from the inner edge of the first blade tip to the inner edge of the second blade tip measures about 2 mm (°1′). The tool features a concave slope (10), designed to impart a gradual rounding to the tips, extending from their outer edge to the tool's midpoint (w1′). This design results in the instrument gradually increasing in thickness along the shaft (9). The midpoint of the tool has a width of about 2 mm (w1′). At this midpoint, there is a U-shaped depression, forming the peak of the concave slope (10), with a depth of about 1 mm to 2 mm.

Optionally, the present invention can have a straight shaft FIG. 8 (9), or various curved shafts as shown in FIG. 9A (15), FIG. 9B (16), FIG. 9C (17). Curved shafts allow the tool to conform to different anatomical structures and facilitate various entry angles for tooth extractions. The foregoing merely illustrates the principles of the present invention. Therefore, it will be appreciated that those skilled in the art will be able to devise numerous alternative arrangements that, while not shown or described herein, embody the principles of the invention and thus are within the spirit and scope of the invention.

### BRIEF DESCRIPTION OF THE DRAWINGS

FIG. 1 is a side view of the prior art Diamond-V″ and the '779 Iwaki patent.

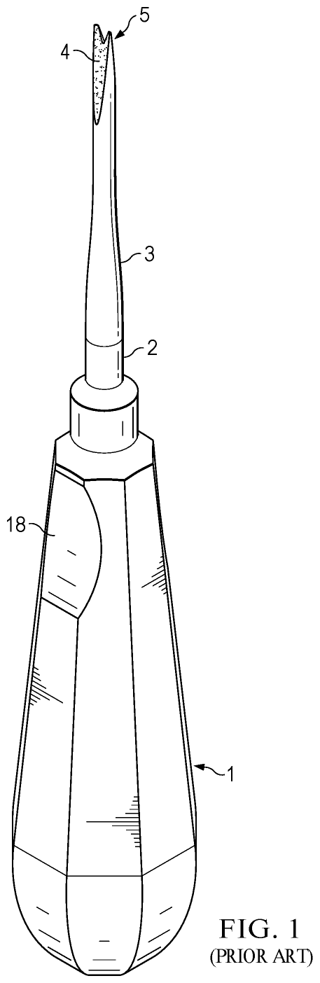

FIG. 2 is a front view representation of the real word forked tip breakage of the prior art Diamond-V″ and the '779 Iwaki patent.

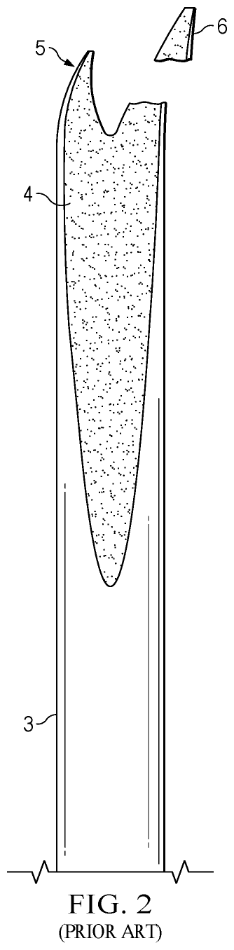

FIG. 3 is a front view of the forked thin pointed tips of prior art Diamond-V″ and the '779 Iwaki patent.

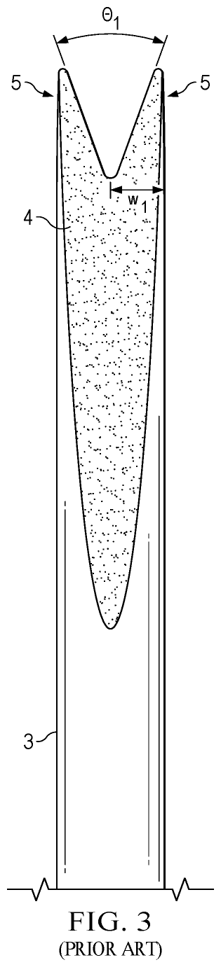

FIG. 4 is a side view of the forked thin pointed tips of prior art Diamond-V″ and the '779 Iwaki patent.

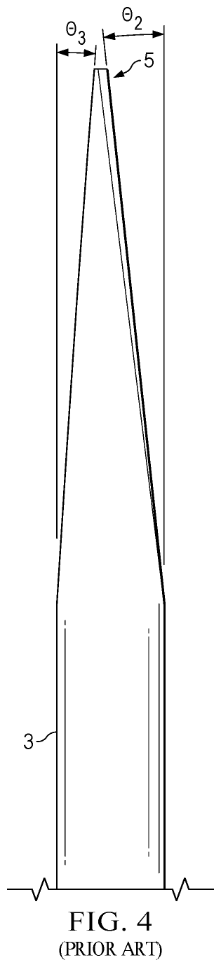

FIG. 5 is a side view of the present invention showing the resilient doubled bladed flat tips.

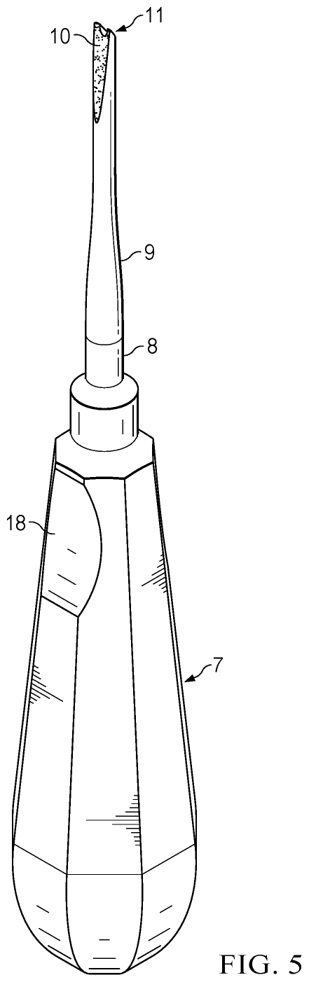

FIG. 6 is a front view of the present invention showing the split U shaft with the doubled bladed flat tips.

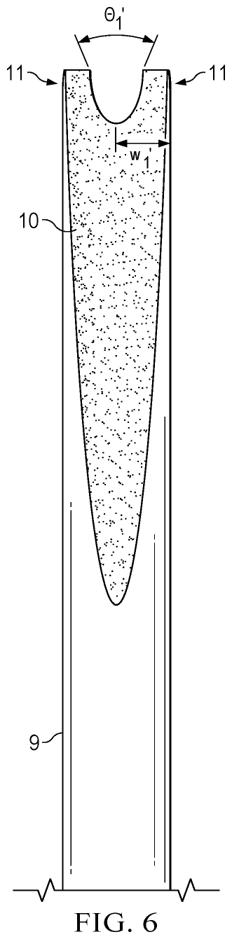

FIG. 7 is a side view of the present invention.

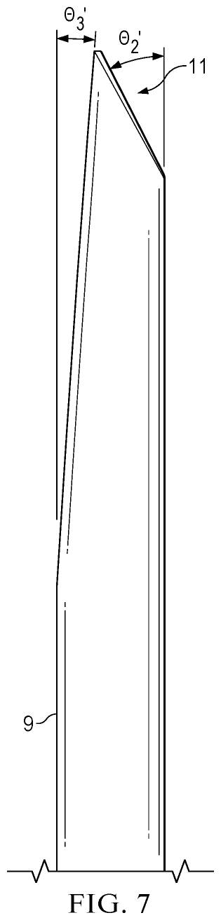

FIG. 8 is an operational view of the present invention extracting a tooth.

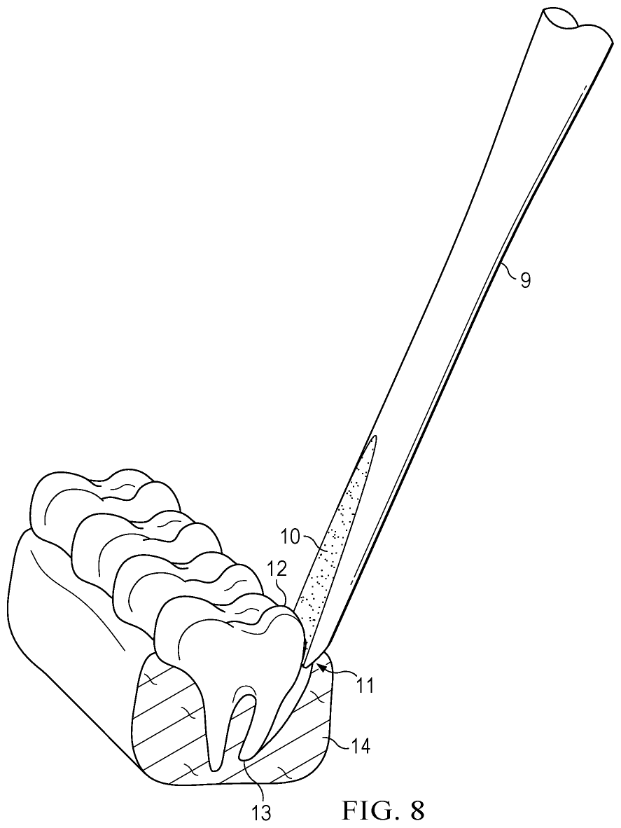

FIG. 9A is a side view of the present invention showing an optional shaft curvature for the tool.

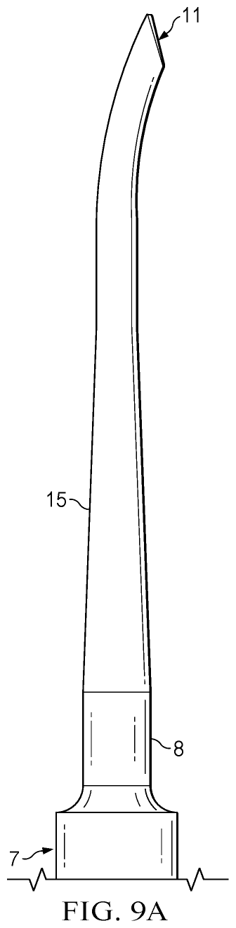

FIG. 9B is a side view of the present invention showing an optional shaft curvature for the tool.

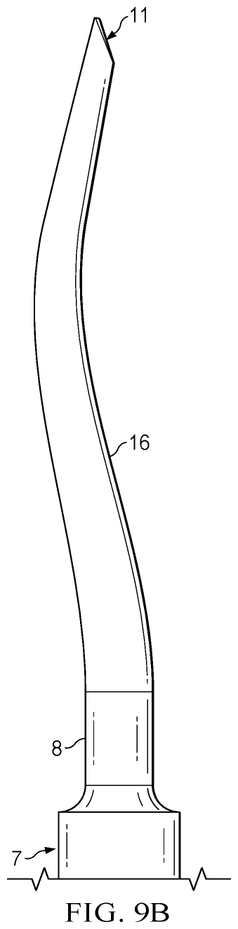

FIG. 9C is a side view of the present invention showing an optional shaft curvature for the tool.

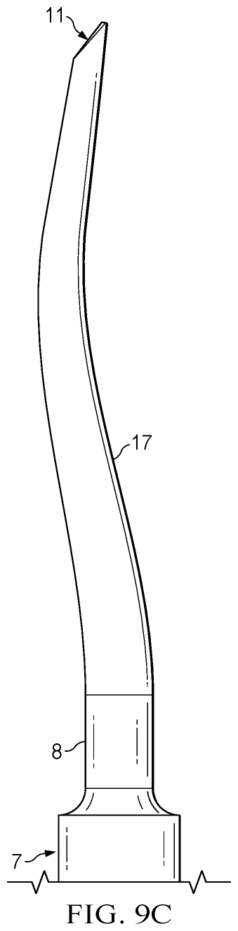

FIG. 10A is a front view of forked prior art from OSUNG USA, V-Notch Periosteal Elevator.

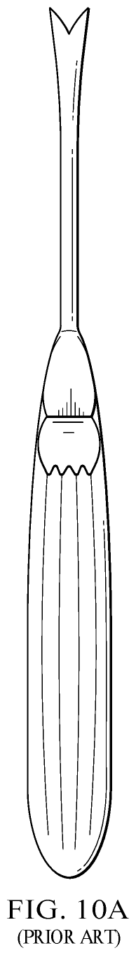

FIG. 10B is a front view of forked prior art from JorVet; Denta Elevator w/V Top.

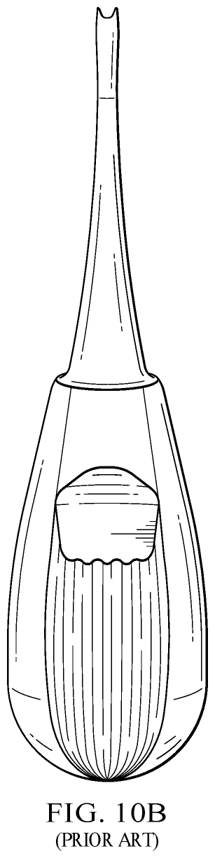

FIG. 10C is a front view of forked prior art from Peak Surgicals, Notched Elevator.

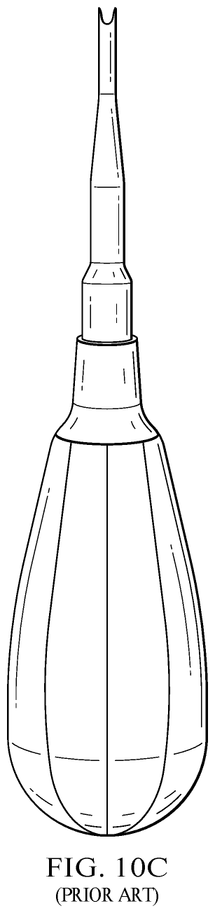

FIG. 10D is a front view of forked prior art from GerVetUsa, Notched Elevator.

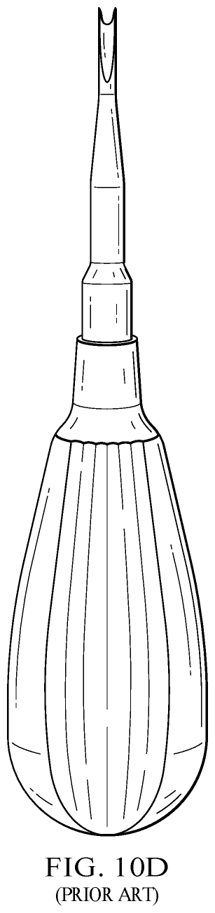

1. A double bladed dental tooth elevator for dental use, comprising:
a handle;
a shaft extending from the handle, the shaft having a shaft reduction area leading to a tool tip;
said tool tip at the end of the shaft, the tool tip having a notch forming double-blades, wherein the notch is adapted for engagement in tooth extraction procedures;
a gripper integrated with the handle, configured to facilitate a firm grip on the tooth during extraction.

2. The dental tooth elevator of claim 1, wherein the double-blades are designed to be resistant to bending and breaking, enabling the instrument to withstand repeated twisting movements by the operator in mesio-distal (backward) and bucco-lingual (side-to-side) directions during tooth extraction.

3. The dental tooth elevator of claim 1, further composing a thumb and pointer finger support notch located on the handle to provide ergonomic support for the user's fingers, thereby enhancing control and precision during the extraction process.

4. The dental tooth elevator of claim 1, wherein the shaft comprises a curvature variation designed to conform to different anatomical structures and facilitate various entry angles for tooth extractions.

5. The dental tooth elevator of claim 1, wherein the double-blades further resists slippage during tooth extraction, unlike traditional straight or pointed tipped elevators.

6. The dental tooth elevator of claim 1, wherein the shaft reduction area facing the tooth being extracted is corrugated up to the notch forming the double-blades and further resists slippage during tooth extraction, unlike traditional straight or pointed tipped elevators.

7. The dental tooth elevator of claim 1, wherein the shaft reduction area facing the tooth being extracted is a rough texture up to the notch forming the double-blades and further resists slippage during tooth extraction, unlike traditional straight or pointed tipped elevators.

8. The dental tooth elevator of claim 1, wherein the wider orientation of the double-blades, when turned sideways, provides increased strength and resilience compared to prior-art instruments with thin, pointed tips.

9. The dental tooth elevator of claim 1, wherein the double-bladed dental tooth elevator is specifically adapted to expand and loosen teeth between tooth and bone, facilitating tooth movement and easing extraction.
